(19) United States
(12) Patent Application Publication
(10) Pub. No.: US 2025/0290604 A1
(43) Pub. Date: Sep. 18, 2025

(54) PRESSURE REDUCER FOR ENABLING THE USE OF POLYMER PIPES FOR THERMAL PRESSURE RELIEF DEVICES OF HYDROGEN-OPERATED VEHICLES

(71) Applicant: NORMA GERMANY GMBH, Maintal (DE)

(72) Inventors: Daniel KINTEA, Maintal (DE); Alexander HAAS, Maintal (DE); Jérome BRONNER, Briey (FR); Gerrit VON BREITENBACH, Maintal (DE)

(21) Appl. No.: 18/856,285

(22) PCT Filed: Jan. 13, 2023
(86) PCT No.: PCT/EP2023/050711

§ 371 Date: Oct. 11, 2024

(30) Foreign Application Priority Data
Apr. 13, 2022 (DE) 10 2022 109 125.2

(51) Int. Cl. F17C 13/04

(52) U.S. Cl. CPC F17C 13/04; F17C 2205/0332; F17C 2221/012; F17C 2270/0178

(57) ABSTRACT

A pressure-reducing system for a high-pressure tank, in particular for a high-pressure tank of a motor vehicle, in which high-pressure tank a fluid is stored under positive pressure. The high-pressure tank has an outlet for relieving the pressure. The high-pressure tank is fluidically connected by way of the outlet to a thermal pressure relief device through which the fluid flows in the flow direction (x) when the pressure is relieved. A pressure reducer for reducing the pressure when relieving the pressure of the high-pressure tank is provided in the thermal pressure relief device.

### INTRODUCTION

The disclosure relates to a pressure-reducing system for a high-pressure tank.

In vehicles that are powered by hydrogen or natural gas, for example, high-pressure tanks are used for storing fuel. Pressures of several hundred bar, such as 700 bar in the passenger motor vehicle sector, for example, are typical in high-pressure tanks of this type.

For safety reasons, the high-pressure tanks are equipped with a thermal pressure relief device, the latter regularly being a pipe system, or a relief pipe, which empties the high-pressure tanks in the event of a vehicle fire.

Relief pipes, or thermal pressure relief devices, which are directly coupled to a hydrogen high-pressure tank are already known from the prior art. These are typically stainless steel pipes which have a relatively high mechanical strength and as a result withstand elevated pressure conditions when the fuel flows out. Depending on the concept of the system, the line pressure reaches up to approx. 80-95% of the tank pressure when the thermal pressure relief device is activated and the hydrogen flows from the high-pressure tank into the pipeline.

It is disadvantageous herein that the stainless steel pipes are relatively heavy and moreover expensive to produce.

### SUMMARY

It is an object per an embodiment to overcome these and further disadvantages of the prior art and to achieve an improved pressure-reducing system for high-pressure tanks in hydrogen-operated motor vehicles, which is constructed in a cost-effective manner using simple means and at the same time has a low dead weight.

In a pressure-reducing system for a high-pressure tank, in particular for a high-pressure tank of a motor vehicle, in which high-pressure tank a fluid is stored under positive pressure, wherein the high-pressure tank has an outlet for relieving the pressure, wherein the high-pressure tank is fluidically connected by way of the outlet to a thermal pressure relief device through which the fluid flows in the flow direction when the pressure is relieved, provided according to an embodiment in the thermal pressure relief device is a pressure reducer for reducing the pressure when relieving the pressure of the high-pressure tank.

An embodiment achieves the present object in a surprisingly simple manner by using the additional pressure reducer within the thermal pressure relief device. The pressure reducer reduces the pressure in the thermal pressure relief device so that the latter can be made of a significantly more cost-effective and lighter plastics material, in particular of a polymer material. In this way, a system for venting high-pressure tanks that guarantees a low pressure in the pipe when relieving the pressure may be provided.

The pressure reducer is preferably, per an embodiment, a restrictor valve, wherein the restrictor valve has a restrictor opening. Due to the restrictor valve, the pressure at the outlet of the high-pressure tank and within the thermal pressure relief device is effectively reduced downstream of the, or in the, flow direction, respectively. It is preferable, per an embodiment, that the restrictor valve is designed as an annular restrictor. This represents a cost-effective variant of construction and thus furthermore lowers the overall manufacturing costs. Alternatively, other restrictor geometries which are cost-effective to produce, such as a simple perforated sheet-metal plate, for example, would also be conceivable.

The restrictor opening is preferably, per an embodiment, designed to be smaller in diameter than the outlet and the thermal pressure relief device. An effective reduction of the total pressure in the system, or an increase in entropy, is achieved as a result. At the same time, the restrictor reduces the static pressure in the thermal pressure relief device downstream of the, or in the, flow direction.

According to a further variant of an embodiment, the restrictor valve is disposed indirectly on the outlet of the high-pressure tank and within the thermal pressure relief device. Due to the spacing between the outlet and the restrictor, no excessively high pressure peaks are advantageously created in the region of the outlet, or at the pipe inlet of the thermal pressure relief device, during the outflow operation.

According to an embodiment, it provides that the thermal pressure relief device is designed as a relief pipe, wherein the outlet has a diameter which corresponds to a pipe diameter of the thermal pressure relief device. A uniform flow rate of mass is guaranteed when flowing through the relief pipe. Due to the restrictor valve, the density of the fuel is reduced when flowing through the relief pipe. In order to compensate for the reduction in the density, the diameter of the outlet, or of the relief pipe, are in principle of larger dimensions than in the known solutions from the prior art, as a result of which a sufficient flow rate of mass is achieved despite the restriction.

According to an embodiment the thermal pressure relief device is designed as a polymer pipe. Polymer pipes are particularly cost-effective to produce, and at the same time very light in direct comparison to stainless steel pipes. The polymer pipe herein can be produced by a simple injection-molding method, for example.

According to an embodiment, it provides that the pressure reducer accelerates the flow to ultrasonic speed at the outlet. Due to the acceleration of the fluid, or fuel, to the ultrasonic range, an effective reduction of pressure can be achieved downstream of the, or in the, flow direction, respectively, in the thermal pressure relief device.

The pressure reducer herein is preferably, per an embodiment, a Laval nozzle, wherein the Laval nozzle has a converging portion and a diverging portion. The Laval nozzle is preferably, per an embodiment, disposed between the outlet and the thermal pressure relief device, wherein the converging portion of the Laval nozzle is disposed directly and immediately on the outlet of the high-pressure tank. As a result of the disposal of the Laval nozzle, the static pressure can be reduced without lowering the total pressure in the system. With the aid of the Laval nozzle on the outlet of the high-pressure tank, or on the pipe inlet of the thermal pressure relief device, the outflowing fuel is accelerated to ultrasonic speed. An additional acceleration to ultrasonic flow, i.e. to Mach values >1, can take place in the diverging portion of the Laval nozzle. Since the static pressure decreases as the Mach value increases, this leads to a significant reduction of pressure in the thermal pressure relief device at a constant total pressure, i.e. the acceleration takes place so as to be substantially isentropic. Due to this interaction the diameter of the thermal pressure relief device, or of the relief pipe, respectively, can be of a smaller dimension than in the restrictor construction. The flow in the entire relief pipe preferably remains in the ultrasonic range, even if this flow decreases due to the frictional forces.

In an embodiment the Laval nozzle has a reduced neck diameter, wherein the converging portion of the Laval nozzle, after reaching the neck diameter, transitions directly into the diverging portion. Alternatively, the converging portion of the Laval nozzle can also transition steadily into the diverging portion and have a slight axial extent in the region of the neck diameter.

In the Laval nozzle construction the outlet preferably, per an embodiment, has a diameter which is designed to be smaller than a pipe diameter of the thermal pressure relief device. The Laval nozzle herein preferably, per an embodiment, has a circular or elliptic cross-sectional area over its entire length. The narrowest cross section of the Laval nozzle preferably, per an embodiment, corresponds to the neck diameter, wherein the flow reaches the speed of sound at the neck diameter and is accelerated to the ultrasonic range in the diverging portion.

### BRIEF DESCRIPTION OF THE FIGURES

Further features, details and advantages of the disclosure are derived from the wording of the claims and from the description hereunder of exemplary embodiments with reference to the drawings in which:

FIG. 1a shows a schematic view of a high-pressure tank having a thermal relief pipe from the prior art;

FIG. 1b shows a schematic view of a pressure-reducing system according to an embodiment;

FIG. 1c shows a schematic view of a further embodiment of a pressure-reducing system.

### DETAILED DESCRIPTION

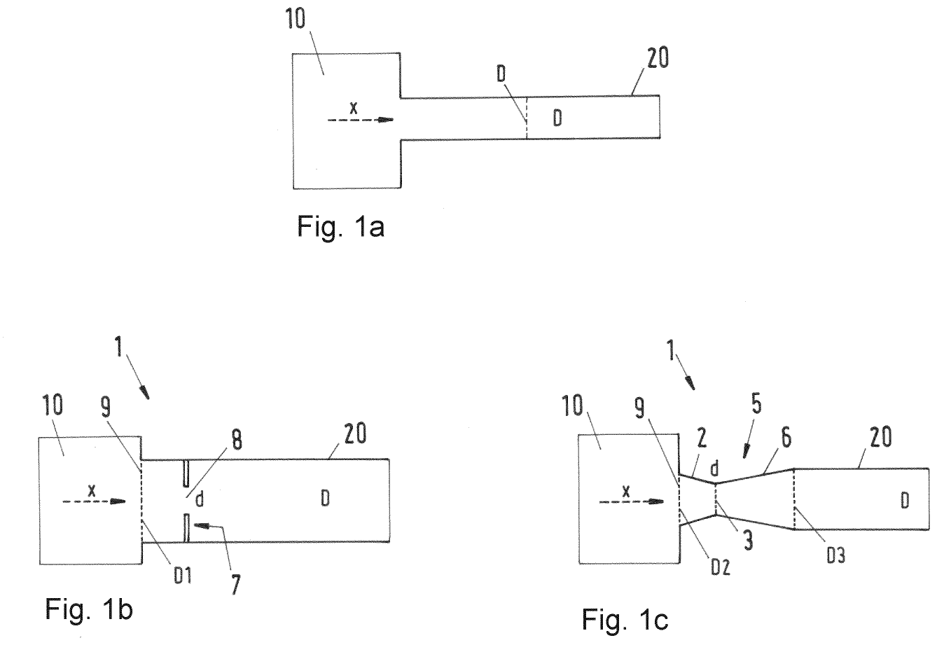

FIG. 1a shows a high-pressure tank 10 in which hydrogen can be stored under high pressure. The high-pressure tank 10 is coupled to a thermal pressure relief device 20 on an outlet side. The thermal pressure relief device 20 herein is designed as a relief pipe and has a pipe diameter D. When the pressure in the high-pressure tank 10 is relieved, the fuel flows in the flow direction (x) into the thermal pressure relief device 20. The arrangement corresponds to the prior art.

FIG. 1b is a schematic illustration of a pressure-reducing system for hydrogen-operated motor vehicles having at least one high-pressure tank 10 in which fuel is stored under positive pressure. The high-pressure tank 10 has an outlet 9 for relieving the pressure, by way of which the high-pressure tank 10 is fluidically connected to a thermal pressure relief device 20.

The thermal pressure relief device 20 is designed as a relief pipe. When the pressure is relieved, the fuel flows in the flow direction x through the relief pipe. The outlet 9 herein has a diameter D1 which corresponds to a pipe diameter of the thermal pressure relief device 20, or of the relief pipe, respectively.

A pressure reducer 1 is disposed on the outlet 9 within the relief pipe. The pressure reducer 1 in the embodiment shown is designed as a restrictor valve 7 and has a restrictor opening 8. This is in particular an annular restrictor.

FIG. 1c schematically shows a further embodiment. In FIG. 1c, a Laval nozzle 5 is disposed instead of the restrictor valve 7 from FIG. 1b, wherein the thermal pressure relief device is also designed as a relief pipe in this embodiment.

The Laval nozzle 5 herein has a converging portion 2 and a diverging portion 6. The Laval nozzle 5 is disposed between the outlet 9 and the thermal pressure relief device 20, or a portion of the relief pipe with a constant profile, respectively. The converging portion 2 of the Laval nozzle 5 is disposed directly and immediately on the outlet 9 of the high-pressure tank 10.

The Laval nozzle 5 furthermore has a neck diameter 3, wherein the converging portion 2 of the Laval nozzle 5 immediately after reaching the neck diameter 3 transitions into the diverging portion 6. The outlet 9 has a diameter D2 which is designed to be smaller than a pipe diameter D3 of the relief pipe, or of the thermal pressure relief device 20, respectively. The neck diameter 3 herein has the smallest cross section, or diameter, of the Laval nozzle 5.

The pressure-reducing system according to an embodiment can relate to high-pressure vessels and thermal pressure relief devices in general. The disclosure relates in particular to hydrogen-operated vehicles which usually have a high-pressure tank that is filled with hydrogen under positive pressure. Due to the increased risk of explosion and fire in the event of accidents or the like, the disclosure is used in particular for venting high-pressure tanks of this type. In principle however, the pressure-reducing system can also be implemented in a stationary high-pressure vessel with a thermal pressure relief device.

All of the features and advantages derived from the claims, the description and the drawing, including structural details, spatial arrangements and method steps, may be essential to the invention individually as well as in the most varied combinations.

Furthermore, in general, while a multitude of embodiments have been depicted and described with a multitude of components in each embodiment, in alternative embodiments the components of various embodiments could be intermixed, combined, and/or exchanged for one another. In other words, components described in connection with a particular embodiment are not necessarily exclusive to that particular embodiment.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

D Diameter (standard)
D1 Diameter outlet (restrictor)
D2 Diameter outlet (Laval)
D3 Diameter relief pipe (Laval)
x Flow direction
1 Pressure reducer
2 Converging portion
3 Neck diameter (Laval)
5 Laval nozzle
6 Diverging portion
7 Restrictor valve
8 Restrictor opening
9 Outlet
10 High-pressure tank
20 Thermal pressure relief device

1. A pressure-reducing system for a high-pressure tank, in which high-pressure tank a fluid is stored under positive pressure, wherein the high-pressure tank has an outlet for relieving the pressure, wherein the high-pressure tank is fluidically connected by way of the outlet to a thermal pressure relief device through which the fluid flows in the flow direction when the pressure is relieved, wherein a pressure reducer for reducing the pressure when relieving the pressure of the high-pressure tank is provided in the thermal pressure relief device.

2. The pressure-reducing system as claimed in claim 1, wherein the pressure reducer is a restrictor valve, wherein the restrictor valve has a restrictor opening and is in particular designed as an annular restrictor.

3. The pressure-reducing system as claimed in claim 2, wherein the thermal pressure relief device is designed as a relief pipe, wherein the outlet has a diameter which corresponds to a pipe diameter of the thermal pressure relief device.

4. The pressure-reducing system as claimed in claim 2, wherein the restrictor opening is designed to be smaller in diameter than the outlet and the thermal pressure relief device.

5. The pressure-reducing system as claimed in claim 2, wherein the restrictor valve is disposed indirectly on the outlet of the high-pressure tank and within the thermal pressure relief device.

6. The pressure-reducing system as claimed in claim 1, wherein the pressure reducer accelerates the flow to ultrasonic speed.

7. The pressure-reducing system as claimed in claim 6, wherein the pressure reducer is a Laval nozzle, wherein the Laval nozzle has a converging portion and a diverging portion.

8. The pressure-reducing system as claimed in claim 7, wherein the Laval nozzle is disposed between the outlet and the thermal pressure relief device, wherein the converging portion of the Laval nozzle is disposed directly and immediately on the outlet of the high-pressure tank.

9. The pressure-reducing system as claimed in claim 7, wherein the Laval nozzle has a neck diameter, wherein the converging portion of the Laval nozzle, after reaching the neck diameter, transitions directly into the diverging portion.

10. The pressure-reducing system as claimed in claim 7, wherein the thermal pressure relief device is designed as a relief pipe, wherein the outlet has a diameter which is designed to be smaller than a pipe diameter of the thermal pressure relief device.

11. The pressure-reducing system as claimed in claim 1, wherein the high-pressure tank is a motor vehicle high-pressure tank.
